(19) United States
(12) Patent Application Publication
(10) Pub. No.: US 2014/0046624 A1
(43) Pub. Date: Feb. 13, 2014

(54) LOCATION MAPPED BY THE FREQUENCY OF THE LIGHT EMITTED BY AN ARTIFICIAL LIGHT SOURCE

(71) Applicant: Pasi Antti Kalevi MIETTINEN, Tampere (FI)

(72) Inventor: Pasi Antti Kalevi MIETTINEN, Tampere (FI)

(73) Assignee: Qualcomm Atheros, Inc., San Jose, CA (US)

(21) Appl. No.: 13/569,982

(22) Filed: Aug. 8, 2012

(51) Int. Cl. G01B 11/14; G06F 15/00

(52) U.S. Cl. 702/150

(57) ABSTRACT

A mobile device may determine its location within an environment having a plurality of light sources in response to the unique frequencies and the predetermined locations of the light sources. For some embodiments, the mobile device can determine its location by detecting the frequencies of light signals emitted from the light sources, providing the determined frequencies as search keys to retrieve the predetermined locations of the light sources from a look-up table, detecting the intensity of light signals emitted from the light sources, correlating the light intensities to distances, and then calculating the position of the mobile device in response to the correlated distances and the predetermined locations of the light sources.

### TECHNICAL FIELD

The present embodiments relate generally to positioning systems, and specifically to determining the location of a mobile device relative to optical sources.

### BACKGROUND OF RELATED ART

Modern positioning systems typically use a global navigation satellite system (GNSS) and/or access points associated with a wireless local area network (WLAN) to determine the location of a mobile device such as a smartphone. However, the feasibility of such positioning systems depends upon the mobile device's ability to receive signals from satellites and/or from the WLAN access points. Thus, while GNSS signals may not be readily available inside structures such as shopping malls and office buildings, WLAN positioning systems depend upon the deployment and activation of a plurality of nearby access points. Further, because of the limited range of RF signals used by WLAN access points and because of multi-path effects associated with such RF signals, WLAN positioning systems may be inaccurate in environments that have narrow and/or winding passages. Thus, GNSS and WLAN positioning systems may be ineffective for position determination in environments such as underground tunnel systems, bomb shelters, basements, and other structures for which GNSS signals are not available and for which WLAN access points are not visible, suffer from limited ranges, and/or are associated with severe multi-path effects.

Thus, it is desirable to provide a positioning system that does not rely upon the availability of GNSS or WLAN signals.

### SUMMARY

An optical positioning system and method are disclosed that allows a device to calculate its position relative to a number of light sources (e.g., light bulbs, infrared emitters, and so on) having known positions. In accordance with the present embodiments, the optical positioning system includes a plurality of light sources provided within an environment, a location look-up table (LUT) that stores the location coordinates of the light sources and the frequencies of light signals emitted therefrom, and a mobile device that includes an optical sensor, the location LUT, a light intensity and frequency measuring module or circuit, a distance correlation module or circuit, and a positioning module or circuit.

To determine its position relative to a selected number of the light sources, the mobile device first receives light signals from the selected light sources. Then, the mobile device determines the intensity and frequency of the light signals emitted from each of the selected light sources. The mobile device retrieves the predetermined locations of the selected light sources from the location LUT (e.g., using the determined frequencies as search keys). The intensities of the light signals received from the selected light sources are correlated to distances between the light sources and the mobile device, and then the correlated distances and the predetermined locations of the selected light sources are used to calculate the position of the mobile device, for example, using trilateration techniques.

For some embodiments, the location coordinates of the light sources may be determined using any suitable method including, for example, manually surveying the environment and then mapping the locations of the light sources. The frequency of light signals emitted by each of the light sources may be determined using a suitable optical sensor and/or measuring device. Further, for some embodiments, the light sources used for position determination have substantially stationary locations, although their locations may be changed as long as their location coordinates are updated within the location LUT.

In this manner, the mobile device may advantageously determine its position without receiving GNSS signals and/or without being within range of WLAN access points.

### BRIEF DESCRIPTION OF THE DRAWINGS

The present embodiments are illustrated by way of example and are not intended to be limited by the figures of the accompanying drawings, where:

FIG. 1 is a block diagram of an optical positioning system within which the present embodiments may be implemented;

FIG. 2 is a block diagram of a mobile device in accordance with some embodiments;

FIG. 3 shows an exemplary embodiment of the light source location look-up table (LUT) of FIG. 2;

FIG. 4 is a sequence diagram depicting a position determination operation in accordance with some embodiments; and

FIG. 5 is an illustrative flow chart depicting position determination operations in accordance with the present embodiments.

### DETAILED DESCRIPTION

The present embodiments are described below in the context of position determination operations performed by a mobile device and a plurality of light sources emitting visible light for simplicity only. It is to be understood that the present embodiments are equally applicable to determining the position of a mobile device relative to optical sources that emit invisible optical signals (e.g., infrared signals). Thus, as used herein, the term “light source” refers to any device that emits visible optical signals (e.g., light) and/or non-visible optical signals (e.g., infrared and ultraviolet signals), and the term “light signals” refers to both visible and invisible optical signals. Further, lights sources that emit visible light may be any suitable type of light source including, for example, incandescent light bulbs, fluorescent light bulbs, light-emitting diodes (LEDs), and so on.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

As mentioned above, in accordance with the present embodiments, a mobile device can determine its location within an environment having a plurality of light sources in response to the unique frequencies and the predetermined locations of the light sources. For some embodiments, the mobile device can determine its location by detecting the frequencies of light signals emitted from the light sources, providing the determined frequencies as search keys to retrieve the predetermined locations of the light sources from a look-up table, detecting the intensity of light signals emitted from the light sources, correlating the light intensities to distances, and then calculating the position of the mobile device in response to the correlated distances and the predetermined locations of the light sources (e.g., using trilateration techniques).

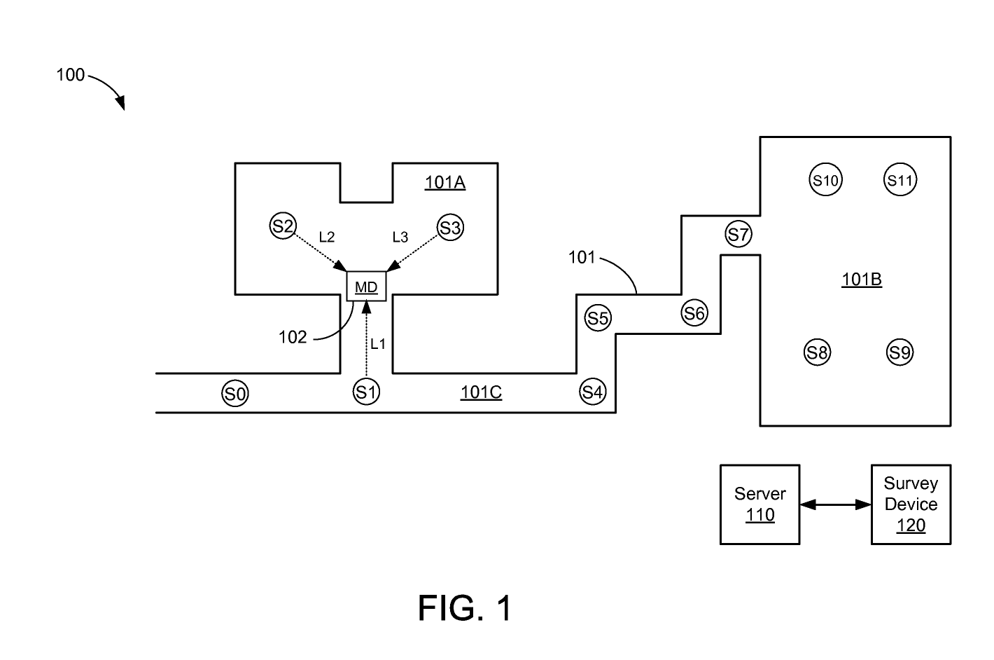

FIG. 1 is a block diagram of an optical positioning system 100 in accordance with the present embodiments. The optical positioning system 100 is shown to include a plurality of light sources S0-S11 located within an environment 101 that can be used to determine the position of a mobile device (MD) 102. Environment 101 can be any suitable structure or area (e.g., a hall, room, tunnel, floor, patio, maze, shelter, basement, bunker, ship, plane, and so on) to which light sources S0-S11 may be attached or otherwise affixed. Thus, although depicted in FIG. 1 as including two substantially rectangular areas 101A-101B connected by a hallway 101C, environment 101 can be of any suitable size, shape, and dimension. Further, although environment 101 is shown to include twelve light sources S0-S11, for actual embodiments, environment 101 can include any number of light sources having any suitable predetermined locations.

Each of the light sources S0-S11 emits light signals at a unique frequency. For some embodiments, the flickering frequency of visible light signals may be used. For the exemplary embodiments described herein, light sources S0-S11 are lamps that emit visible light signals. However, for actual embodiments, light sources S0-S11 can be any device or element emitting optical signals that can be detected by an optical sensor provided within and/or associated with mobile device 102. Thus, the light signals emitted from light sources S0-S11 can include visible light and/or invisible light (e.g., UV radiation, infrared signals, and so on).

The mobile device 102 may be any suitable mobile communication device including, for example, a cell phone, PDA, tablet computer, laptop computer, or the like. For the embodiments described herein, the mobile device 102 may include an optical sensor, a light source location look-up table (LUT), a light intensity and frequency measurement module, a distance correlation module, and a positioning module. The optical sensor may detect the intensity and frequency of light emitted from nearby light sources S0-S11. The light source location LUT stores the location coordinates of light sources S0-S11 along with the unique frequencies of light signals emitted therefrom. The light intensity and frequency measurement module may measure the intensity and/or frequency of light signals received from light sources S0-S11. The distance correlation module may correlate the intensity of light signals received from light sources S0-S11 to distances between the mobile device 102 and the light sources S0-S11. The positioning module may determine the position of the mobile device 102 using distances between the mobile device 102 and a suitable number of the light sources S0-S11. For some embodiments, the intensity and frequency measuring module, the distance correlation module, and/or the positioning module may be implemented using well-known software modules, hardware components, and/or a suitable combination thereof). Thus, for some embodiments, the mobile device 102 may include a processor that executes such software modules.

Further, optical positioning system 100 is shown to include and/or be associated with a server 110 and a survey device 120. The survey device 120 may be any well-known device that surveys environment 101 and maps the locations of the light sources S0-S11. Further, for the present embodiments, survey device 120 also includes or is associated with optical sensors (not shown for simplicity) that measure the frequency of light signals emitted from light sources S0-S11. Server 110, which may be any suitable server that is accessible by survey device 120 and mobile device 102, stores the locations of the light sources S0-S11 and the frequency of light signals emitted therefrom. For some embodiments, survey device 120 can be coupled to server 110 (e.g., either via a wired or wireless connection) to allow the light source locations and frequencies determined by survey device 120 to be provided to and thereafter stored in server 110, and mobile device 102 can be coupled to server 110 (e.g., either via a wired or wireless connection) to allow the light source locations and frequencies stored in server 110 to be communicated to and thereafter stored in mobile device 102.

For other embodiments, mobile device 102 may instead be a stationary device or a device having a relatively fixed location, and/or may have a wired or wireless connection with server 110.

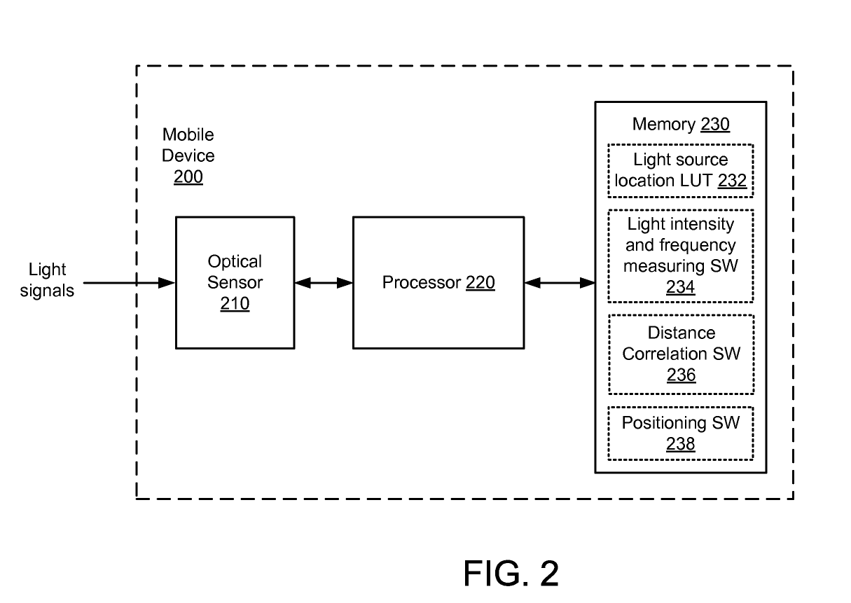

FIG. 2 shows a mobile device 200 that is one embodiment of mobile device 102 of FIG. 1. Mobile device 200 includes an optical sensor 210, a processor 220, and a memory 230. Optical sensor 210 receives light signals emitted from one or more of light sources S0-S11, and may determine the received intensity (e.g., power level) and/or the frequency of the received light signals.

Memory 230 includes a light source location LUT 232 that stores the location coordinates of light sources S0-S11 and the frequency of signals emitted by corresponding light sources S0-S11. For some embodiments, light source location LUT 232 may store other relevant information for each of light sources S0-S11 (e.g., the type of signals emitted therefrom, the uniqueness of the frequency of the emitted signals, and so on).

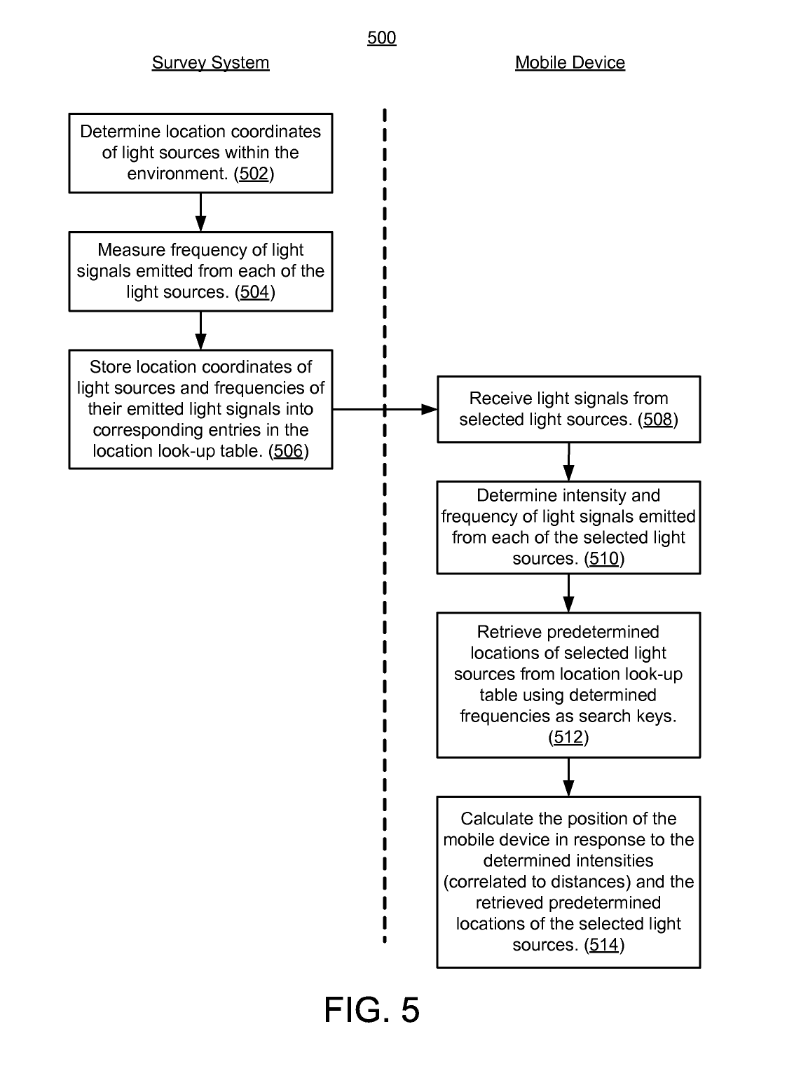

Memory 230 may also include a non-transitory computer-readable medium (e.g., one or more nonvolatile memory elements, such as EPROM, EEPROM, Flash memory, a hard drive, and so on) that can store one or more of the following software modules:
a light intensity and frequency measuring software module 234 to measure the intensity and frequency of light signals received from one or more selected light sources S0-S11 (e.g., as described for operation 510 of FIG. 5);
a distance correlation software module 236 to correlate the intensity of light signals received from one or more selected light sources S0-S11 to distances between mobile device 200 and each of the selected light sources S0-S11 (e.g., as described for operation 514 of FIG. 5); and
a positioning software module 238 to determine the location of the mobile device 200 based upon the known locations of the selected light sources S0-S11 and the distances between them and mobile device 200 (e.g., as described for operation 514 of FIG. 5).
   Each software module can include instructions that, when executed by processor 220, can cause the mobile device 200 to perform the corresponding functions. Thus, the non-transitory computer-readable medium of memory 230 can include instructions for performing all or a portion of the mobile device side of operations of method 500 of FIG. 5.

Processor 220, which is coupled to optical sensor 210 and memory 230, may be any suitable processor capable of executing scripts or instructions of one or more software programs stored in the mobile device 200 (e.g., within memory 230). For example, processor 220 may execute light intensity and frequency measuring software module 234 to measure the intensity and frequency of light signals received from one or more selected light sources S0-S11. For other embodiments, such measurements may be performed by optical sensor 210. Processor 220 may execute distance correlation software module 236 to correlate the intensity of light signals received from one or more selected light sources S0-S11 to distances between mobile device 200 and each of the selected light sources S0-S11. Then, processor 220 may provide these distances, along with the location coordinates of the selected light sources S0-S11 (e.g., as retrieved from the light source location LUT 232) to positioning software module 238. Thereafter, processor 220 may execute positioning module 238 to determine the location of the mobile device 200 using the location coordinates of at least three selected light sources S0-S11 as reference points (e.g., using trilateration techniques).

Further, although not shown in FIG. 2 for simplicity, mobile device 200 may also include a global navigation satellite system (GNSS) module, a transmitter/receiver circuit, and/or a scanner. The GNSS module, which is well-known, can determine the current location of the mobile device 200 if mobile device 200 has a line-of sight with a suitable number of positioning satellites. The transmitter/receiver circuit, which is well-known, can be used to transmit signals to and receive signals from one or more visible WLAN access points (not shown for simplicity), from server 110 of FIG. 1, and/or from survey device 120 of FIG. 1. The scanner, which is well-known, can be used to scan the surrounding environment to detect and identify nearby access points.

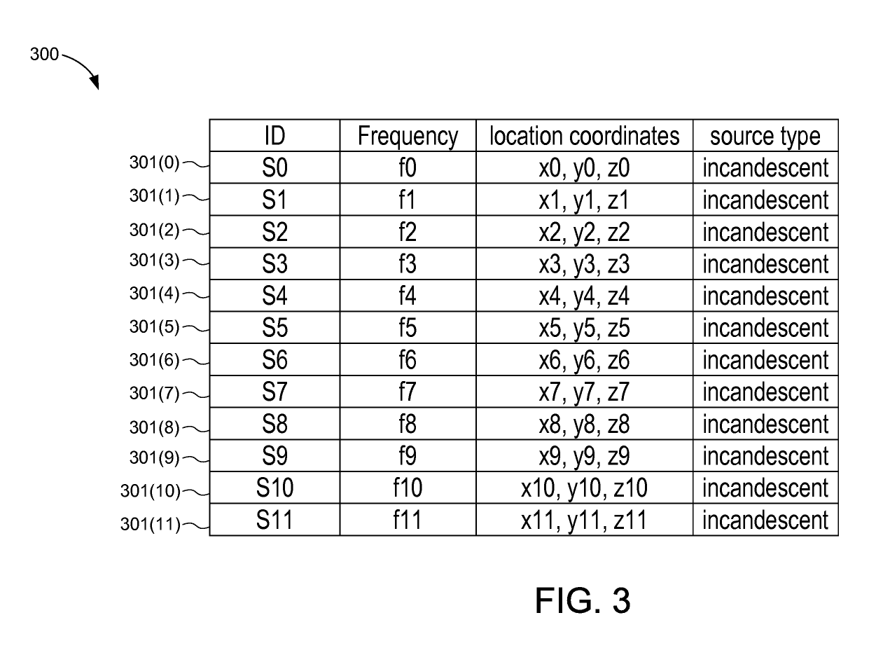

FIG. 3 shows a light source location LUT 300 that is one embodiment of the light source location LUT 232 of FIG. 2. Light source location LUT 300 is shown to include twelve entries 301(0)-301(11), each for storing an identifier (e.g., name or number) of the corresponding light source, the frequency of light signals emitted by the corresponding light source, and the type of light source (e.g., incandescent, fluorescent, LED, infrared, and so on). For example, entry 301(0) corresponds to light source S0, and indicates that light source S0 emits light signals having a frequency of f0, has location coordinates LC0={x0, y0, z0}, and is an incandescent light bulb. Similarly, entry 301(1) corresponds to light source S1, and indicates that light source S1 emits light signals having a frequency of f1, has location coordinates LC1={x1, y1, z1}, and is an incandescent light bulb, and so on.

As mentioned above, for other embodiments, one or more of entries 301(0)-301(11) of location LUT 300 may include other fields to store additional information about the corresponding light source (e.g., an indication of the uniqueness of the frequency of its emitted light signals). Thus, for some embodiments, location LUT 300 may include additional fields not depicted in the exemplary embodiment of FIG. 3.

Further, for other embodiments, location LUT 300 may also be stored within server 110 and/or other memory element provided within or otherwise associated with environment 101 of FIG. 1. For such embodiments, mobile device 200 may access and retrieve the location coordinates of light sources S0-S11 directly or indirectly from the server 110 and/or survey device 120 associated with environment 101 (e.g., if not already stored in the light source location LUT 232 within mobile device 200).

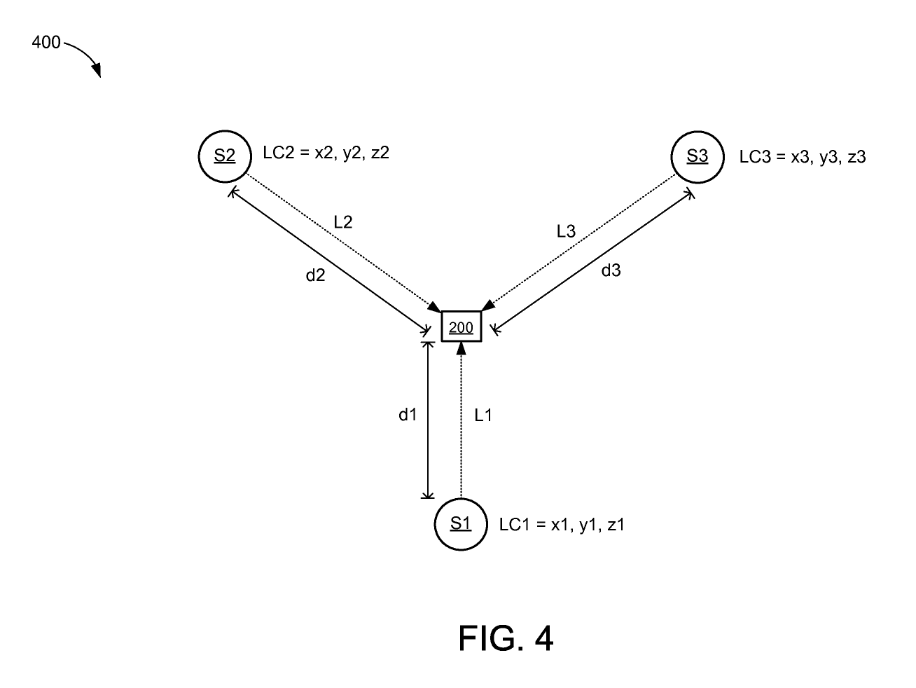

An exemplary position determination operation performed by the optical positioning system 100 of FIG. 1 is depicted in the sequence diagram 400 of FIG. 4. Referring also to FIGS. 2 and 3, mobile device 200 is positioned such that its optical sensor 210 receives light signals L1-L3 from selected light sources S1-S3, respectively. As depicted in FIG. 4, light source S1 has predetermined location coordinates of LC1={x1, y1, z1} and is a first distance d1 from mobile device 200, light source S2 has predetermined location coordinates of LC2={x2, y2, z2} and is a second distance d2 from mobile device 200, and light source S3 has predetermined location coordinates of LC3={x3, y3, z3} and is a third distance d3 from mobile device 200.

Before determining its position with respect to selected light sources S1-S3, the mobile device 200 acquires the location coordinates of the selected light sources S1-S3 and the unique frequencies of the light signals L1-L3 emitted from light sources S1-S3, respectively. As mentioned above, the location coordinates of the selected light sources S1-S3 may be determined by using survey device 120 to map the locations of light sources S0-S11 associated with environment 101 of FIG. 1, and the frequency of light signals emitted by each of light sources S0-S11 may be measured using the optical sensor provided within and/or associated with the survey device 120. Then, the location coordinates of the light sources S0-S11 and the frequencies of their emitted light signals are stored into corresponding entries in the location LUT 232 provided within or otherwise accessible by mobile device 200.

Then, once the location coordinates and the frequencies of light signals emitted from the light sources S0-S11 are stored in the location LUT 232 and thereby accessible by mobile device 200, mobile device 200 may determine its position using the light sources S0-S11 as reference points. More specifically, to determine its position using the selected light sources S1-S3 as reference points, the mobile device 200 uses its optical sensor 210 to receive light signals L1-L3 from corresponding selected light sources S1-S3. Then, mobile device 200 determines the intensity and frequency of the light signals L1-L3, for example, either by using optical sensor 210 or by having processor 220 execute the light intensity and frequency measuring software module 234. For other embodiments, mobile device 200 may determine the intensity and/or frequency of the light signals L1-L3 using other suitable techniques such as, for example, specialized hardware components (e.g., ASICs or FPGAs) and/or other software modules.

Once the frequencies of light signals L1-L3 are known, mobile device 200 can provide these frequencies as search keys to location LUT 232 to retrieve the location coordinates of each of the selected light sources S1-S3. For example, processor 220 may provide the measured frequency of light signal L1 as a first search key (SK1=f1) to location LUT 232 and thereafter retrieve the location coordinates LC1={x1, y1, z1) from matching entry 301(1) of location LUT 232 (e.g., because the search key value SK1=f1 matches the frequency f1 stored in LUT entry 301(1)). Similarly, processor 220 may provide the measured frequency of light signal L2 as a second search key (SK2=f2) to location LUT 232 and thereafter retrieve the location coordinates LC2={x2, y2, z2) from matching entry 301(2) of location LUT 232, and may provide the measured frequency of light signal L3 as a third search key (SK3=f3) to location LUT 232 and thereafter retrieve the location coordinates LC3={x3, y3, z3) from matching entry 301(3) of location LUT 232.

Mobile device 200 may correlate the measured intensities of light signals L1-L3 to the distances d1-d3 between mobile device 200 and each of selected light sources S1-S3, for example, by having processor 220 execute the distance correlation software module 236. For some embodiments, the relationship between the intensity (E) of a given light source at a point P and the distance (d) between the light source and point P may be expressed as:

$$E = \frac{φ}{4 π d} ,$$

where φ is total luminous flux of the light source.

Of course, for other embodiments, other suitable correlation techniques may be used to correlate the intensity of light signals L1-L3 to distances d1-d3, respectively.

Once the location coordinates of the selected light sources S1-S3 are retrieved and the distances between mobile device 200 and each of the selected light sources S1-S3 have been determined, mobile device 200 can calculate its position relative to the selected light sources S1-S3, for example, by having processor 220 execute positioning software module 238. For some embodiments, trilateration techniques disclosed in commonly owned U.S. Pat. No. 7,899,472, the entirety of which is incorporated by reference herein, can be used to calculate the position of mobile device 200 in response to the location coordinates of the selected light sources S1-S3 and the distances d1-d3 between them and mobile device.

For example, as disclosed in U.S. Pat. No. 7,899,472, if the location coordinates of light source S1 are LC1={x1, y1, z1}), the location coordinates of light source S2 are LC2={x2, y2, z2}, and the location coordinates of light source S3 are LC3={x3, y3, z3}, then computing the location coordinates of mobile device 200 as P=(xp, yp, zp) includes using a set of equations:

xp=(w1*x1)+(w2*×x2)+(w3*×x3)

yp=(w1*y1)+(w2*y2)+(w3*y3), and

zp=(w1*z1)+(w2*z2)+(w3*z3),

wherein

w1=(1/d1)/(1/d1+1/d2+1/d3),

w2=(1/d2)/(1/d1+1/d2+1/d3), and

w3=(1/d3)/(1/d1+1/d2+1/d3).

FIG. 5 is an illustrative flowchart depicting a method 500 for performing position determination operations in accordance with the present embodiments. Referring also to FIGS. 1-4, the location coordinates of the light sources S0-S11 are first determined (502), and then the frequency of light signals emitted by each of light sources S0-S11 are measured (504). The location coordinates may be determined, for example, by manually surveying the environment 101 to map the location coordinates of corresponding light sources S0-S11 using survey device 120. The frequency of light signals emitted by each of light sources S0-S11 may be measured, for example, using an optical sensor provided within and/or associated with the survey device 120. Next, the location coordinates of light sources S0-S11 and the frequencies of their emitted light signals are stored into corresponding entries in the location LUT 232 (506). As mentioned above, the location LUT 232 may be provided within mobile device 200, within server 110, or both.

Then, once the location coordinates and the frequencies of light signals emitted from the light sources S0-S11 are stored in the location LUT 232 and thereby accessible by mobile device 200, mobile device 200 may determine its position using the light sources S0-S11 as reference points. More specifically, the mobile device 200 first receives light signals from a number of selected light sources S1-S3 (508). Then, mobile device 200 determines the intensity and frequency of the light signals emitted from each of the selected light sources S1-S3 (510). The mobile device 200 retrieves the predetermined locations of the selected light sources S1-S3 from the location LUT 232 using the determined frequencies as search keys (512). The intensities of the light signals received from the selected light sources S1-S3 are correlated to distances d1-d3, respectively, and then correlated distances d1-d3 and the predetermined locations of the selected light sources S1-S3 are used to calculate the position of the mobile device 200, for example, using trilateration techniques (514).

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. For example, method steps depicted in the flow chart of FIG. 5 may be performed in other suitable orders and/or one or more methods steps may be omitted. For another example, although optical sensor 210 is shown in FIG. 2 as being provided within mobile device 200, for other embodiments, the optical sensor may be an external component that can be removably attached to mobile device 200 (e.g., as a plug-in component coupled to a smartphone or tablet computer).

What is claimed is:

1. In an environment having a plurality of light sources each having a predetermined location and each emitting light signals having a unique frequency, a method of determining a position of a mobile device within the environment, the method comprising:
receiving, in an optical sensor provided within the mobile device, light signals emitted from a number of selected light sources;
determining an intensity and the frequency of the light signals emitted from each of the selected light sources;
retrieving, from a look-up table, the predetermined locations of the selected light sources in response to the determined frequencies; and
calculating the position of the mobile device in response to the determined intensities and the retrieved predetermined locations of the selected light sources.

2. The method of claim 1, wherein the look-up table is provided within the mobile device.

3. The method of claim 1, wherein the look-up table is provided within a server separate from and accessible by the mobile device.

4. The method of claim 1, wherein the look-up table comprises a plurality of entries, each entry storing the frequency of the light signals emitted from a corresponding light source and the predetermined location of the corresponding light source.

5. The method of claim 4, wherein the retrieving comprises:
providing the determined frequency as a search key to the look-up table; and
accessing the predetermined location stored in a matching entry of the look-up table in response to the search key.

6. The method of claim 1, wherein the calculating comprises:
correlating each determined intensity to a distance between the mobile device and the corresponding selected light source; and
deriving the position of the mobile device in response to the correlated distances and the predetermined locations of the selected light sources.

7. The method of claim 1, further comprising:
obtaining the predetermined locations of the light sources by surveying the environment;
measuring the unique frequency of the light signals emitted from each of the light sources; and
storing the predetermined locations and the unique frequencies in corresponding entries of the look-up table.

8. The method of claim 1, wherein the light signals do not contain any positional information of the light sources.

9. A system including a mobile device to determine the position of the mobile device in an environment having a plurality of light sources each having a predetermined location and each emitting light signals having a unique frequency, wherein the mobile device comprises:
means for receiving light signals emitted from a number of selected light sources;
means for determining an intensity and the frequency of the light signals emitted from each of the selected light sources;
means for retrieving the predetermined locations of the selected light sources from a look-up table in response to the determined frequencies; and
means for calculating the position of the mobile device in response to the determined intensities and the retrieved predetermined locations of the selected light sources.

10. The system of claim 9, wherein the look-up table is provided within the mobile device.

11. The system of claim 9, wherein the look-up table comprises a plurality of entries, each entry storing the frequency of the light signals emitted from a corresponding light source and the predetermined location of the corresponding light source.

12. The system of claim 11, wherein the means for retrieving comprises:
means for providing the determined frequency as a search key to the look-up table; and
means for accessing the predetermined location stored in a matching entry of the look-up table in response to the search key.

13. The system of claim 9, wherein the means for calculating comprises:
means for correlating each determined intensity to a distance between the mobile device and the corresponding selected light source; and
means for deriving the position of the mobile device in response to the correlated distances and the predetermined locations of the selected light sources.

14. The system of claim 9, further comprising:
means for obtaining the predetermined locations of the light sources by surveying the environment;
means for measuring the unique frequency of the light signals emitted from each of the light sources; and
means for storing the predetermined locations and the unique frequencies in corresponding entries of the look-up table.

15. The system of claim 9, wherein the light signals do not contain any positional information of the light sources.

16. A mobile device to determine its position in an environment having a plurality of light sources each having a predetermined location and each emitting light signals having a unique frequency, wherein the mobile device comprises:
a processor; and
a memory coupled to the processor and having stored therein computer-executable instructions that when executed by the processor cause the mobile device to:
receive, in an optical sensor provided within the mobile device, light signals emitted from a number of selected light sources;
determine an intensity and the frequency of the light signals emitted from each of the selected light sources;
retrieve, from a look-up table, the predetermined locations of the selected light sources in response to the determined frequencies; and
calculate the position of the mobile device in response to the determined intensities and the retrieved predetermined locations of the selected light sources.

17. The mobile device of claim 16, wherein the look-up table is provided within the mobile device.

18. The mobile device of claim 16, wherein the look-up table is provided within a server separate from and accessible by the mobile device.

19. The mobile device of claim 16, wherein the look-up table comprises a plurality of entries, each entry storing the frequency of the light signals emitted from a corresponding light source and the predetermined location of the corresponding light source.

20. The mobile device of claim 16, wherein when retrieving the predetermined locations of the selected light sources, the instructions further cause the mobile device to:
provide the determined frequency as a search key to the look-up table; and
access the predetermined location addressed by the search key.

21. The mobile device of claim 16, wherein when calculating the position of the mobile device, the instructions further cause the mobile device to:
correlate each determined intensity to a distance between the mobile device and the corresponding selected light source; and
derive the position of the mobile device in response to the correlated distances and the predetermined locations of the selected light sources.

22. The mobile device of claim 16, wherein the light signals do not contain any positional information of the light sources.
